(19) United States
(12) Patent Application Publication
(10) Pub. No.: US 2006/0167726 A1
(43) Pub. Date: Jul. 27, 2006

(54) Office routine work management system and office routine work management method

(75) Inventors: Tadashi Asanuma, Minato-ku (JP); Naoko Hiraizumi, Minato-ku (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MITSUI CHEMICALS, INC, Minato-ku (JP)

(21) Appl. No.: 10/562,823

(22) PCT Filed: Jun. 22, 2004
(86) PCT No.: PCT/JP04/09080

§ 371 Date: Dec. 29, 2005

(30) Foreign Application Priority Data
Jul. 1, 2003 (JP) 2003-189480

(51) Int. Cl. G06F 17/50

(52) U.S. Cl. 705/7

(57) ABSTRACT

A system and method for managing the procedure of an office work is capable of saving an individual or a corporation the trouble of managing the procedure of the office work and performing a reasonable and reliable procedure of the office work by collectively managing a submit period of documents and an answer to an administrative organ.

A period managing system includes at least a management condition creating unit 1, a management information storing unit 2, a management condition determining unit 3, and a management condition storing unit 4. The period managing system is operated on the basis of period management information stored in the management condition storing unit. The system for managing the procedure of the office work performs document exchange between the client and the administrative organ by exchanging the document with the client and/or the administrative organ while managing the period by the period managing system, thereby managing the procedure of the office work.

### TECHNICAL FIELD

The present invention relates to a system and method for managing the procedure of an office work, and more particularly, to a system and method for managing the procedure of an office work capable of saving a corporation or the like the trouble of managing the procedure of the office work and performing a reasonable procedure of the office work by collectively managing a submit period of documents and an answer to an administrative organ.

### BACKGROUND ART

When submitting a document to an administrative organ, it is necessary to follow a predetermined rule and a predetermined form. Accordingly, occupations carrying out the business are created. Especially, the business related to the intellectual property rights, such as a patent, a utility model, a trademark, and a design, is complicated, and thus period management thereof is needed. When the patent is applied to foreign countries, the rules are different from each other every country, so that the work is getting more complicated. Although it is possible to ask an agent to manage the work, it cannot get rid of pains for paperwork. Even for the agent, managing the period or the procedure of an office work is complicated. Managing the period or the procedure of an office work is complicated, but does not require specialty or wide knowledge corresponding to science. However, each agent is bothered by the complicated procedure of the office work because, if the period or the procedure of the office work is not properly managed, the desired patent right cannot be acquired, resulting in a fatal mistake.

A method for simplifying works by connecting an agent and a client through the communication line (for example, see JP-A-2001-134661) and a method for reliably managing a period by using a computer (for example, see JP-A-2001-331599) have been proposed. However, a method for rationalizing and reliably performing the procedure of an office work by unifying the office work management is not disclosed.

Currently, the individual or the corporation manages the complicated procedure of the office work, which requires a lot of efforts. Accordingly, the expense is getting very heavy, and mistakes occur frequently. The mistake may be generated from even a person specialized in the management of the procedure of an office work. If the mistake corresponding to the procedure occurs, it may prove a fatal mistake regardless of the specialty of a person in charge. Accordingly serious problems may arise.

The methods disclosed in JP-A-2001-134661 and JP-A-2001-331599 are effective, but the methods cannot solve the trouble and lack of reliability concerning the procedure of an office work.

When the procedure of the office work can be intensively managed, an individual and a corporation, especially, an inventor, a patent attorney, and a lawyer, can concentrate on their original works requiring specialty, and the period management of the procedure can be performed by a third party, which makes it possible to improve reliability. It is extremely effective and reasonable if there is a specific method for implementing a concentrated managing method.

### DISCLOSURE OF THE INVENTION

In order to solve the above-mentioned problems, the inventors design a method of intensively managing only the procedure of an office work by assiduous examination.

According to an aspect of the invention, there is provided a system for managing the procedure of an office work of managing a period for exchanging documents with an administrative organ and/or an answer to the administrative organ, which starts a period management by inputting entrusted contents from a plurality of client, such as an individual and/or a corporation to the period managing system, and starts the period management of corresponding action of acquiring documents or something by inputting the information of the acquiring documents or something from the administrative organ to the period management system, and transmits period management information and the information of the documents or something to the client by an information delivering unit, and always provides to only the clients the information stored in the period managing system by the period managing system using web site, and performs the document exchange between the client and the administrative organ by exchanging the document with the client and/or the administrative organ while managing the period by the period managing system.

According to another aspect of the invention, there is provided a method for managing the procedure of an office work of managing a period for exchanging documents with an administrative organ and/or an answer to the administrative organ, which starts period management by inputting entrusted contents from a plurality of client, such as an individual and/or a corporation to the period managing system, and starts the period management of corresponding action of acquiring documents or something by inputting the information of the acquiring documents or something from the administrative organ to the period management system, and transmits period management information and the information of the documents or something to the client by an information delivering unit, and always provides to only the clients the information stored in the period managing system by the period managing system using web site, and performs the document exchange between the client and the administrative organ by exchanging the document with the client and/or the administrative organ while managing the period by the period managing system.

### BRIEF DESCRIPTION OF THE DRAWINGS

FIG. 1 is a view of showing the structure of a system of managing the procedure of an office work according to an embodiment of the present invention.

### BEST MODE FOR CARRYING OUT THE INVENTION

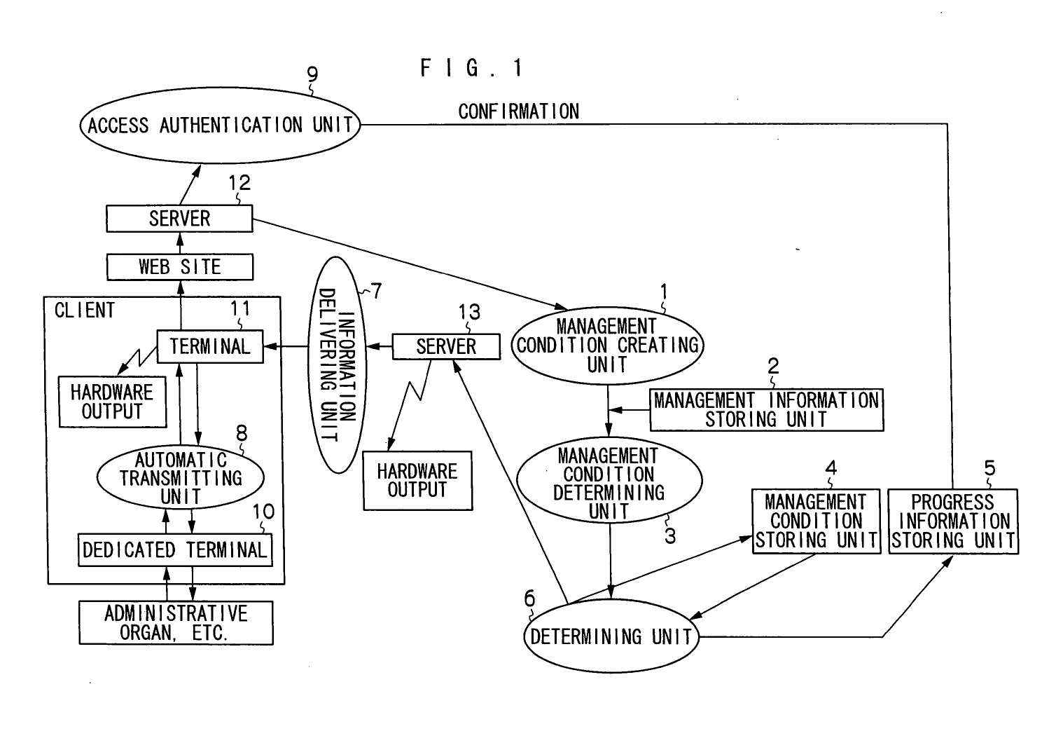

Hereinafter, preferred embodiments of a system for managing the procedure of an office work according to the present invention will be described in detail. FIG. 1 shows an example of the structure of the system for managing the procedure of an office work.

In the present invention, an administrative organ means a government office or an agent of the government office. For example, in the case in which the procedure of an office work to be managed is related to the industrial property right such as an application for a patent, the government office is a patent office.

In addition, in the present invention, a corporation means all organizations corresponding to the administrative organs except for the individual.

Furthermore, in the present invention, a document means all of documents (including electronic data) being exchanged between a client, such as the individual and/or the corporation, and the administrative organ when the client goes through a procedure on the administrative organ.

Furthermore, in the present invention, a period managing system is a system used for operating the system for managing the procedure of an office work of the present invention. The period managing system includes at least a management condition creating unit, a management information storing unit, a management condition determining unit, and a management condition storing unit. The period managing system is preferably operated on the basis of period management information which has been determined as appropriate by the managing condition determining unit and then has been stored in the managing condition storing unit.

Hereinafter, the detail of the present invention is described with reference to FIG. 1.

A plurality of clients, such as the individual and/or the corporation, entrusts the period management. The contents of the entrustment are written in a check sheet having a predetermined format regarding for inputting to the system and are then directly inputted into a web site connected to the period managing system. Alternately, they can be received through a mail service or FAX and then can be input by hands or OCS. In this way, the entrusted content is input to the period managing system.

The check sheet written when the client entrusts includes the items needed for managing the procedure of the office work such as procedures to be managed, items to be managed at every procedure, and methods of the management, in advance. The client can select desired items from the above-mentioned items according to the contents to be entrusted.

The input data are transmitted to a management condition creating unit 1, which will be described later in detail, and the conditions including the contents to be managed, the contents to be informed to the client and a period to be informed to the client are created.

Secondly, the conditions created by the management condition creating unit 1 are compared with the information related to the condition determined by the law stored in the management information storing unit by the management condition determining unit 3, and thus the validity of the conditions entrusted by the client, which are created by the management condition creating unit 1, is determined. If it is determined that the conditions are not different from the conditions stored in a management information storing unit 2 so that the conditions are appropriate, the information is stored in a management condition storing unit 4. If there is any problem, the information created by the management condition creating unit 1 is output in order for confirmation. In this case, for example, marking can be performed such that the difference can be immediately understood. The difference is confirmed by the client in some ways, and modified data is transmitted to the management condition creating unit 1 again. Data related to the management information entrusted by the client is stored in the management condition storing unit 4, and among them, the information relating to the period management becomes the period managing information.

Meanwhile, the information transmitted from the administrative organ is input to a dedicated terminal 10. This information is converted into a format capable of being received in the period managing system, and is then transmitted from a client terminal 11 to a server 12 through a public line and a web site. The data is transmitted from the server 12 to the management condition creating unit 1 again and is then compared with the information stored in the management information storing unit 2 by the management condition determining unit 3. Then, the validity of the conditions created by the management condition creating unit 1 is determined. If this information is not different from the conditions stored in the management information storing unit 2, the information is transmitted to a determining unit 6. If there is any problem, the information created by the management condition creating unit 1 is output in order for confirmation. In the determining unit 6, the information transmitted to the determining unit 6 is compared with the management information stored in the management condition storing unit 4. If the information needs to be managed, it is additionally stored in the management condition storing unit 4, and is additionally stored in a progress information storing unit 5 together with the other information. Information to be transmitted to the client at the same time is transmitted to the client through an output server 13 by an information delivering unit 7.

Meanwhile, when the time to transmit the period management information among the management information to the client comes, with the lapse of time, the information stored in the management condition storing unit 4 is transmitted to the server 13 by the determining unit 6, and is converted into a predetermined format for reporting in the information delivering unit 7, and then the information is transmitted to the client through the public line.

In this case, it is preferred that a check sheet be appended to the period management information to be transmitted to the client. The check sheet appended to the period management information indicates what the period management information is related to, when the answer is expired, and so on. In addition, the check sheet may indicate items which is useful for the client to simply understand the state, such as letters of the law corresponding to the information. Also, the check sheet written when the client entrusts the period management can be used.

The information to be submitted to the administrative organ of the information items transmitted to the client is converted into a format suitable for the administrative organ and is then transmitted from the terminal 11 to the dedicated terminal 10. In this way, the document is submitted to the administrative organ from the dedicated terminal 10.

On the other side, the information which does not need to be submitted from the dedicated terminal is transmitted from the determining unit 6 to the server 13, and is output as it is. Then, the information is sent to the administrative organ by a mail or is directly submitted thereto by a predetermined method.

In the online procedure of, for example, a patent application, it is preferable to provide an automatic transmitting unit 8 for transmitting the data sent from the administrative organ to the client to the period managing system, and for transmitting documents sent from the period managing system to the client to the administrative organ. It is more preferable that the automatic transmitting unit 8 have both a function for converting the format of information and a function for transmitting the information.

The information stored in the period managing system, such as the information stored in the progress information storing unit 5, is always provided to only the client by the period managing system through a web site. At this time, if the client accesses the web site, an access authentication unit 9 identifies the accessed person, and enables the authorized person to read only requested items of the stored information.

In the present invention, the period managing system exchanges the documents with the client and/or the administrative organ while managing the period in an above-mentioned method. In this way, a necessary procedure to the administrative organ from the client is gone through, and the document exchange between the client and the administrative organ is performed.

Hereinafter, the detail of units constituting the period managing system of the invention will be described.

The management condition creating unit is a unit for creating management conditions including, contents to be managed, contents to be notified to the client, and the time to notify the client, on the basis of the information input by the client.

The management information storing unit is a unit for storing information related to the management contents determined by law, and for changing the information to revised information if there is revision.

The management condition determining unit is a unit for comparing the conditions created by the management condition creating unit with the information stored in the management information storing unit, for storing the conditions created by the management condition creating unit in the management condition storing unit when the conditions created by the management condition creating unit have no problem and are determined as appropriate, and for outputting the conditions in order for confirmation when the conditions created by the management condition creating unit have problems.

The management condition storing unit is a unit for storing management conditions including contents to be managed, contents to be notified to the client, and the time to notify the client. Among the information items stored in the management condition storing unit, information related to the period management serves as the period management information.

The progress information storing unit is a unit for storing the progress of information received in the period managing system with respect to the items entrusted to be managed.

The determining unit is a unit for comparing the information obtained and appended by the administrative organ with the information stored in the management condition storing unit, for determining the conditions needed to be managed, for inputting the information needed to be managed to the management condition storing unit and then inputting it to the progress information storing unit together with the other information, and for outputting the information needed to be subjected to a process, such as notification to the client.

The information delivering unit is a unit for transmitting the information output from the determining unit and the management condition determining unit to the client through the public line.

The access authentication unit is a unit for identifying an accessed person and allowing the client to read only requested items on the information stored in the progress information storing unit when the client accesses the web site in order to read the information stored in the period managing system, such as the progress information.

The automatic transmitting unit is a unit (1) for receiving the information transmitted from the administrative organ to the client, for converting information into a format suitable for the period managing system to transmit the information to the period managing system through the public line, and (2) for converting the output information from the period managing system into a format capable of being submitted to the administrative organ to transmit the information to the administrative organ through the dedicated terminal.

The automatic transmitting unit is generally provided in a system on the client side, but a function for converting the format of information may be provided on the period managing system side. When the function is provided on the period managing system side, the function can be incorporated into the information delivering unit.

The important thing in the present invention is to intensively manage only an office work in the procedure thereof. The actual procedure needs specialty respectively. Acting as the agent needs various licenses, and each case can be assumed that the procedure is executed by an individual, a corporation, or an agent thereof.

The contents to be managed for the office work are determined about each procedure by law. Accordingly such contents are stored in the management information storing unit in a predetermined format.

The client accesses the web site thorough the public line. Then, when authentication succeeds by the access authentication unit, the client can read only the entrusted information for oneself stored in the progress information storing unit and so on in the period managing system.

Hereinafter, the contents accomplished by the system for managing the procedure of an office work of the present invention are described in detail with an example of the patent application.

The client accesses the web site of the period managing system through the terminal, selects the patent application as the procedure according to the check sheet, and inputs the expected date of a patent application. Then, the latest application form is displayed. When input is performed according to the form, information is transmitted to the management condition creating unit. As described above, the created information, such as information on the expected date of the patent application, and at the request of the client, in addition, the client, and the inventor, is stored in the management condition storing unit.

In the case in which a specification can be examined, but the procedure of an office work is simply vicariously executed, when the patent application date comes, a completed application document as information determined by the determining unit is transmitted to the automatic transmitting unit through the terminal of the client, and is then applied to the patent office in an electronic format by the dedicated terminal. At this time, it is preferred that the document completed by the period managing system is the document completed by way of the process wherein the client confirms.

If the application is completed, the application number, the application date, and the application date of a priority document are confirmed by the patent office. This information is input from the web site through the automatic transmitting unit and the client terminal, determined by the determining unit, and stored in the management condition storing unit and the progress information storing unit. Hereinafter, the management of office works, such as confirmation of a request for examination and an answer to an official action can be collectively executed.

The information stored in the period managing system can be referred in the web site, but secret information except for a title can be referred by only a dedicated line for maintaining the secret. Also, voluminous information can be stored in an auxiliary unit other than the management condition storing unit. The opened information can be provided to the client by acquiring the information from a market and by additionally storing it in the progress information storing unit. Also, the management condition determining unit can obtain more accurate information by comparing the information received from the client, and then the information can be stored in the management condition storing unit.

The period managing information stored in the management condition storing unit is transmitted, as predetermined information, to the client through the information delivering unit by, for example, an electronic mail. The client can immediately receive the information by clicking a reference click when requiring detailed information in addition to the transmitted information.

The procedure of an office work to be managed by the system for managing the procedure of an office work of the present invention includes all procedures being performed to the administrative organs as described above and has no limitation. However, it is worth to collectively manage the intellectual property right, preserved by the law, related to the patent application, acquisition of the right of the patent, and maintenance of the patent, which is complicated and has a long administration period. In both domestic and overseas, it is obvious that the kind of a procedure, such as amendment, request for examination, notice of appeal, action for cancellation of appeal, or opposition, is not considered.

### INDUSTRIAL APPLICABILITY

According to the method of managing the procedure of an office work, it is possible to improve the efficiency of a business because the procedure of the office work becomes reasonable such that the patent attorney, the lawyer, and the inventor can concentrates on their businesses having specialty. In addition, the third party who can concentrate on management manages the procedure of an office work, which makes it possible to improve the quality of a business by reducing mistakes. Accordingly, the system and method of the present invention can be effectively used when an individual, a corporation, and an agent thereof go through an administrative procedure on the administrative organ, and have industrially enormous value.

1. A system for managing the procedure of an office work of managing a period for exchanging documents with an administrative organ and/or an answer to the administrative organ, which starts period management by inputting entrusted contents from a plurality of client, such as an individual and/or a corporation to a period managing system, and starts the period management of corresponding action of acquiring documents or something by inputting the information of the acquiring documents or something from the administrative organ to the period management system, and transmits period management information and the information of the documents or something to the client by an information delivering unit, and always provides to only the clients the information stored in the period managing system by the period managing system using web site, and performs the document exchange between the client and the administrative organ by exchanging the document with the client and/or the administrative organ while managing the period by the period managing system.

2. A method for managing the procedure of an office work of managing a period for exchanging documents with an administrative organ and/or an answer to the administrative organ, which starts period management by inputting entrusted contents from a plurality of client, such as an individual and/or a corporation to a period managing system, and starts the period management of corresponding action of acquiring documents or something by inputting the information of the acquiring documents or something from the administrative organ to the period management system, and transmits period management information and the information of the documents or something to the client by an information delivering unit, and always provides to only the clients the information stored in the period managing system by the period managing system using web site, and performs the document exchange between the client and the administrative organ by exchanging the document with the client and/or the administrative organ while managing the period by the period managing system.

3. The system for managing the procedure of an office work according to claim 1,
wherein the period managing system includes at least a management condition creating unit, a management information storing unit, a management condition determining unit, and a management condition storing unit, and
the period managing system is operated on the basis of the period management information which is determined as appropriate information by the management condition determining unit and is stored in the management condition storing unit.

4. The method of managing the procedure of an office work according to claim 2,
wherein the period managing system includes at least a management condition creating unit, a management information storing unit, a management condition determining unit, and a management condition storing unit, and
the period managing system is operated on the basis of the period management information which is determined as appropriate information by the management condition determining unit and is stored in the management condition storing unit.

5. The system for managing the procedure of an office work according to claim 3,
wherein a check sheet is appended to the period management information.

6. The method of managing the procedure of an office work according to claim 4,
wherein a check sheet is appended to the period management information.

7. The system for managing the procedure of an office work according claim 5,
wherein the exchange of the documents between the plurality of clients, such as the individual and/or the corporation, and the administrative organ is performed by transmitting data, which is transmitted from the administrative organ to the client, to the period managing system by using the automatic transmitting unit, and by transmitting the document, which is completed by the period managing system and is then transmitted from the period managing system to the corresponding client, to the administrative organ by using the automatic transmitting unit.

8. The method of managing the procedure of an office work according to claim 6,
wherein the exchange of the documents between the plurality of clients, such as the individual and/or the corporation, and the administrative organ is performed by transmitting data, which is transmitted from the administrative organ to the client, to the period managing system by using the automatic transmitting unit, and by transmitting the document, which is completed by the period managing system and is then transmitted from the period managing system to the corresponding client, to the administrative organ by using the automatic transmitting unit.

9. The system for managing the procedure of an office work according to claim 7,
wherein the document completed by the period managing system is the completed document by way of the process wherein the client confirms the document for submitting to the administrative organ.

10. The method of managing the procedure of an office work according to claim 8,
wherein the document completed by the period managing system is the completed document by way of the process wherein the client confirms the document for submitting to the administrative organ.

11. The system for managing the procedure of an office work according to claim 1,
wherein a check sheet is appended to the period management information.

12. The method of managing the procedure of an office work according to claim 2,
wherein a check sheet is appended to the period management information.

13. The system for managing the procedure of an office work according to claim 11,
wherein the exchange of the documents between the plurality of clients, such as the individual and/or the corporation, and the administrative organ is performed by transmitting data, which is transmitted from the administrative organ to the client, to the period managing system by using the automatic transmitting unit, and by transmitting the document, which is completed by the period managing system and is then transmitted from the period managing system to the corresponding client, to the administrative organ by using the automatic transmitting unit.

14. The system for managing the procedure of an office work according to claim 13,
wherein the document completed by the period managing system is the completed document by way of the process wherein the client confirms the document for submitting to the administrative organ.

15. The system for managing the procedure of an office work according to claim 3,
wherein the exchange of the documents between the plurality of clients, such as the individual and/or the corporation, and the administrative organ is performed by transmitting data, which is transmitted from the administrative organ to the client, to the period managing system by using the automatic transmitting unit, and by transmitting the document, which is completed by the period managing system and is then transmitted from the period managing system to the corresponding client, to the administrative organ by using the automatic transmitting unit.

16. The system for managing the procedure of an office work according to claim 15,
wherein the document completed by the period managing system is the completed document by way of the process wherein the client confirms the document for submitting to the administrative organ.

17. The system for managing the procedure of an office work according to claim 1,
wherein the exchange of the documents between the plurality of clients, such as the individual and/or the corporation, and the administrative organ is performed by transmitting data, which is transmitted from the administrative organ to the client, to the period managing system by using the automatic transmitting unit, and by transmitting the document, which is completed by the period managing system and is then transmitted from the period managing system to the corresponding client, to the administrative organ by using the automatic transmitting unit.

18. The system for managing the procedure of an office work according to claim 17,
wherein the document completed by the period managing system is the completed document by way of the process wherein the client confirms the document for submitting to the administrative organ.

19. The method of managing the procedure of an office work according to claim 12,
wherein the exchange of the documents between the plurality of clients, such as the individual and/or the corporation, and the administrative organ is performed by transmitting data, which is transmitted from the administrative organ to the client, to the period managing system by using the automatic transmitting unit, and by transmitting the document, which is completed by the period managing system and is then transmitted from the period managing system to the corresponding client, to the administrative organ by using the automatic transmitting unit.

20. The method of managing the procedure of an office work according to claim 19,
wherein the document completed by the period managing system is the completed document by way of the process wherein the client confirms the document for submitting to the administrative organ.

21. The method of managing the procedure of an office work according to claim 4,
wherein the exchange of the documents between the plurality of clients, such as the individual and/or the corporation, and the administrative organ is performed by transmitting data, which is transmitted from the administrative organ to the client, to the period managing system by using the automatic transmitting unit, and by transmitting the document, which is completed by the period managing system and is then transmitted from the period managing system to the corresponding client, to the administrative organ by using the automatic transmitting unit.

22. The method of managing the procedure of an office work according to claim 21,
wherein the document completed by the period managing system is the completed document by way of the process wherein the client confirms the document for submitting to the administrative organ.

23. The method of managing the procedure of an office work according to claim 2,
wherein the exchange of the documents between the plurality of clients, such as the individual and/or the corporation, and the administrative organ is performed by transmitting data, which is transmitted from the administrative organ to the client, to the period managing system by using the automatic transmitting unit, and by transmitting the document, which is completed by the period managing system and is then transmitted from the period managing system to the corresponding client, to the administrative organ by using the automatic transmitting unit.

24. The method of managing the procedure of an office work according to claim 23,
wherein the document completed by the period managing system is the completed document by way of the process wherein the client confirms the document for submitting to the administrative organ.
